(19) United States
(12) Patent Application Publication
(10) Pub. No.: US 2014/0350992 A1
(43) Pub. Date: Nov. 27, 2014

(54) INTEGRATED MAINTENANCE SCORING APPARATUS AND METHOD

(71) Applicants: Carl Horton, Draper, UT (US); Brian Haslam, Sandy, UT (US); Randall Sutton, West Jordan, UT (US); Jiajun Liu, Sandy, UT (US)

(72) Inventors: Carl Horton, Draper, UT (US); Brian Haslam, Sandy, UT (US); Randall Sutton, West Jordan, UT (US); Jiajun Liu, Sandy, UT (US)

(21) Appl. No.: 14/285,419

(22) Filed: May 22, 2014

Related U.S. Application Data
(60) Provisional application No. 61/827,525, filed on May 24, 2013.

(51) Int. Cl. G06Q 10/06

(52) U.S. Cl. CPC G06Q 10/06315
USPC 705/7.25

(57) ABSTRACT

Methods and apparatus for computational aggregation of information from an infrastructure system process by analytical programs tracking condition, maintenance, and scoring for both. An integrated score provides additional insights into actual real-life expectations for continued operation for an infrastructure asset. The system may be accessed over a presentation interface that permits “what if” testing, searching for similarly situated assets, incorporation of actual data of inspections and maintenance efforts, as well as data from similarly situated environments and systems. The information may be processed through numerical methods systems and statistical modules in order to obtain correlations, calculations, and predictions of useful life of assets and systems of assets.

### RELATED APPLICATIONS

This application claims the benefit of U.S. Provisional Patent Application Ser. No. 61/827,525, filed May 24, 2014, which is hereby incorporated by reference.

### BACKGROUND

1. Field of the Invention

This invention relates to computer systems and, more particularly, to novel systems and methods for computer systems tracking, controlling, and managing information for physical plant infrastructure systems, such as for cities and industry.

2. Background Art

Machinery is typically visible, accessible, and comparatively smaller than city infrastructure. Accordingly, machines may be regularly maintained, may be replaced readily, may be repaired, accessed, inspected, torn down, rebuilt, and otherwise serviced. Moreover, inspection is possible by meters, measurements, sensors, cameras, and so forth. Meanwhile, tear downs and open inspections are always an option, with some degree of effort, which is typically reasonable.

Thus, the reliability (typically measured by mean time between breakdowns), availability (typically the total percentage or fraction of time that a machine is available for operation), maintainability (typically measured in terms of service hours required per hour of operation, and sometimes by fraction of downtime required for maintenance), and durability (typically measured in lifetime or number of operations or number of output production quanta) may be documented. Meanwhile, the cost, frequency, interference, down time and the like associated with maintenance, repair, failures, and the like may be tracked. Accordingly, financial decisions and capital investment decisions may be made.

In contrast, infrastructure, such as the infrastructure existing within and beneath, as well as overhead in, a city is difficult to monitor. City or industrial infrastructure may include numerous assets, including pipes, other lines, like cables, telephone, power, sewage, storm runoff, and so forth. These are often not available for ready inspection. Herein, a city is an example of any large infrastructure, meaning any plant or industry.

Meanwhile, all types of lines may carry data, power, water, sewage, or the like. They may have fittings, junctions, connections, spans, upstream events in components, downstream events in components, and so forth. Fixtures, controls, connections, and the like may all be present. Cables, wires, poles, equipment, connection boxes, control boxes, and so forth may exist in various types of systems. Equipment, roads, canals, drainages, accesses, crossings, streets, trees, plants (biological or works plants), buildings, ports (whether airports, water ports, or otherwise), and so forth may all exist as infrastructure assets. Signs, walkways, pumps, other facilities, and so forth populate cities, as well as large industrial complexes.

At present, all such assets have an operational lifetime. Operational lifetime is typically specified in a specification included with a request for bids. Accordingly, manufactures, builders, installers, and so forth bid to install a particular infrastructure asset for a particular price.

Typically, a manufacturer or installer may provide a life curve. That life curve is effectively a curve or line that plots available useful life on a y or vertical axis and the passage of time in use on a horizontal or “x” axis. Like a depreciation curve, the asset degrades over time. Once an asset has reached a useful life remainder less than about twenty percent, an asset is subject to replacement. Often, when an asset has a useful life less than about forty percent, periodic failures, ongoing deterioration effects, and the like may begin to cause maintenance and service operations to become too costly. When maintenance costs begin to dwarf capitalization costs, an infrastructure asset may be replaced.

Therein lies the rub. Many assets may be repaired, completely rebuilt, or otherwise put back into operational condition. At present, infrastructure is inspected for its condition. An experienced expert may be able to visually inspect or conduct certain tests on an infrastructure asset that has been opened up for inspection, such as a line that has been dug up. Accordingly, one may estimate the life status or the remaining useful life that appears to be present at a particular location in a particular asset.

It would be an advance in the art to provide improved methods for estimating life of an infrastructure asset. It would be a further improvement to provide more analytic capability for projecting available life of an asset. It would be a further advance in the art to provide a mechanism for incorporating maintenance efforts into a projected life of an infrastructure asset. It would be a further advance in the art to provide analytically predicted life projection. Incorporating similarly situated infrastructure for which data is available, particularly in those cases where data is not available on a particular asset would be an improvement. It would be an improvement to increase data sources to include the attributes of similar assets elsewhere documented, either historically, or at the time of maintenance inspection and installation.

### BRIEF SUMMARY OF THE INVENTION

In view of the foregoing, in accordance with the invention as embodied and broadly described herein, methods and apparatus are disclosed in certain embodiments of the present invention as including a system server maintaining a database of information and predictive analyses including a maintenance score, a maintenance scoring system, and an integrated scoring system incorporating maintenance scoring and condition scoring of infrastructure assets.

In certain embodiments, an infrastructure system, such as the infrastructure of a city may be managed through a work station associated with an employee, agent, agency, responsible individual, or other management organization. Meanwhile, an oversight organization or oversight supervisor may also use information and predictions in order to assist in making decisions. Decisions may involve capital investment, maintenance investment, and analysis of tradeoffs between capital investment and maintenance investment.

In one embodiment of an apparatus and method in accordance with the invention, information from inspection records, as-built records, expenses, assets and attributes of infrastructure elements and systems, work orders and historical accumulations of work done on work orders and the expense thereof in time, money, and so forth, may all be incorporated into a database of records by a work station, or collected by a work station and forwarded to a central or other system computer.

Execution of functions and software may be on standalone computers, networked computers, or over an internetwork between computers.

In one embodiment, a geographical information system (GIS) database available from ESRI may be used. For example, a GIS-enabled database may link information and presentations to geographical positioning of assets, in order to improve the understanding of an individual conducting a query, analysis, or even inputs of data into the system.

In certain embodiments, statistical modules may maintain statistics on attributes of assets. Attributes may include, for example, location, type, dimensions, area, a region or district of responsibility, soils, climate, topology (connections), topography (elevation and geography), geology, materials, dates, ages, manufacturers, event history, workers who have accessed an asset, assessments by those who have worked on or accessed infrastructure elements, records, links, loads, flows, chemistry of contents or surrounding environments, traffic, times, seasons, identifiers, capacities, use cycles or duty cycles, vendors, installers, condition from inspections and reports, costs, condition scores, maintenance scores, integrated scores, and so forth.

Meanwhile, assets may include lines, pipes, fittings, fixtures, controls, connections, cables, poles, equipment, roads, canals, drainages, accesses, crossings, streets, trees, plants, buildings, ports, pumps, facilities, walks, signs, and any other asset that a city or industrial organization may choose to purchase, maintain, track, or the like.

In one embodiment of an apparatus and method in accordance with the invention, those responsible for an asset or various systems of assets may include those with management responsibility, operations, or field work. Others, whether engineering, information technology, staff support, or outside services may provide support, and the like. Meanwhile, those with oversight, such as governmental oversight may also access a system and method in order to assess various information, such as maintenance scoring, integrated scoring, scoring information, and real-life availability, and lifetime expectations projected.

A database in accordance with the invention may access a GIS database a record database, as well as various analyses. Analyses may be conducted based on data stored, and whichever analyses may provide outputs, graphs, charts, projections, predictions, recommendations, and the like. Analyses and visual representations of aggregations thereof may also be saved as records for future reference in order to document decisions, alter decisions, and rethink decisions.

A system and method in accordance with the invention stand in contrast to prior art systems of adopting a manufacturer's lifetime curve of deterioration. With maintenance, deterioration may be slowed, repaired, reversed, or the like. Thus, straight line curves or any other curve provided at installation does not necessarily reflect reality.

Moreover, a system in accordance with the invention may evaluate condition not as a simple function, but the change of condition as a first derivative (mathematically speaking) of the condition. Maintenance upgrades may be incorporated as an alteration or step change to improve or raise a condition. Other changes of the rate of deterioration of condition, or even the second derivative (the rate of change of the rate of change) of condition may be calculated.

Statistical analysis modules as well as numerical methods systems may assist in tracking, correlating, analyzing, predicting, and otherwise modeling system life, system costs, and trade offs between life, usefulness, maintenance, condition, and expenses related thereto.

In certain embodiments, a system and method in accordance with the invention may rely on similarly situated infrastructure assets within the same infrastructure system, within other remote infrastructure systems reported, or both in order to develop actual lifetime projections, predictions, and recommendations.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a schematic block diagram of a computer network, including several nodes or computers, one in detail, connected to a network, a server, and through a router to an internetwork suitable for implementing an apparatus and method in accordance with the invention and hosting software modules in accordance therewith;

FIG. 2 is a schematic block diagram of a system in accordance with the invention including hardware, software, and records for implementing an apparatus and method in accordance with the invention;

FIG. 3 is a schematic diagram of a network architecture for a system of computers implementing one embodiment of a system in accordance with the invention;

FIG. 4 is a schematic diagram of a map or topology of a system of infrastructure assets suitable for management by a system and method in accordance with the invention;

FIG. 5 is a schematic diagram of computer readable memory storing records of assets and their attributes, including a listing of typical assets and a selection of typical attributes corresponding to various assets;

FIG. 6 is a schematic block diagram of a computer readable, non-transitory memory storing certain executable modules for loading into a processor for executing a system and method in accordance with the invention;

FIG. 7 is a schematic block diagram illustrating various interactions between hardware information, executables, and records, in order to implement a system and method in accordance with the invention;

FIG. 8 is a chart illustrating a maintenance score curve and sample events or activities with scoring in order to create such a chart;

FIG. 9 is a chart of a condition score with various historical sample scores taken, based on inspections made on an infrastructure asset; and

FIG. 10 is an integrated chart illustrating a visual representation of condition and maintenance scores for direct correlation and presentation to a user.

### DETAILED DESCRIPTION OF THE PREFERRED EMBODIMENTS

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, as claimed, but is merely representative of various embodiments of the invention. The illustrated embodiments of the invention will be best understood by reference to the drawings, wherein like parts are designated by like numerals throughout.

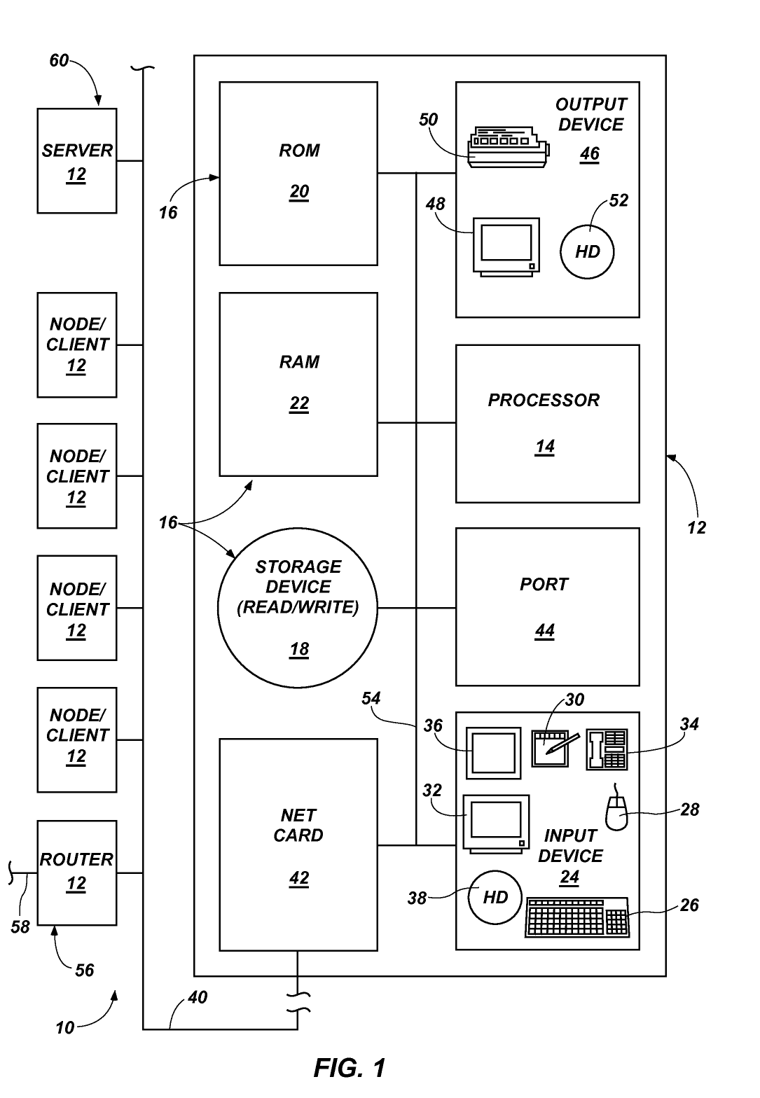

Referring to FIG. 1, an apparatus 10 or system 10 for implementing the present invention may include one or more nodes 12 (e.g., client 12, computer 12). Such nodes 12 may contain a processor 14 or CPU 14. The CPU 14 may be operably connected to a memory device 16. A memory device 16 may include one or more devices such as a hard drive 18 or other non-volatile storage device 18, a read-only memory 20 (ROM 20), and a random access (and usually volatile) memory 22 (RAM 22 or operational memory 22). Such components 14, 16, 18, 20, 22 may exist in a single node 12 or may exist in multiple nodes 12 remote from one another.

In selected embodiments, the apparatus 10 may include an input device 24 for receiving inputs from a user or from another device. Input devices 24 may include one or more physical embodiments. For example, a keyboard 26 may be used for interaction with the user, as may a mouse 28 or stylus pad 30. A touch screen 32, a telephone 34, or simply a telecommunications line 34, may be used for communication with other devices, with a user, or the like. Similarly, a scanner 36 may be used to receive graphical inputs, which may or may not be translated to other formats. A hard drive 38 or other memory device 38 may be used as an input device whether resident within the particular node 12 or some other node 12 connected by a network 40. In selected embodiments, a network card 42 (interface card) or port 44 may be provided within a node 12 to facilitate communication through such a network 40.

In certain embodiments, an output device 46 may be provided within a node 12, or accessible within the apparatus 10. Output devices 46 may include one or more physical hardware units. For example, in general, a port 44 may be used to accept inputs into and send outputs from the node 12. Nevertheless, a monitor 48 may provide outputs to a user for feedback during a process, or for assisting two-way communication between the processor 14 and a user. A printer 50, a hard drive 52, or other device may be used for outputting information as output devices 46.

Internally, a bus 54, or plurality of buses 54, may operably interconnect the processor 14, memory devices 16, input devices 24, output devices 46, network card 42, and port 44. The bus 54 may be thought of as a data carrier. As such, the bus 54 may be embodied in numerous configurations. Wire, fiber optic line, wireless electromagnetic communications by visible light, infrared, and radio frequencies may likewise be implemented as appropriate for the bus 54 and the network 40.

In general, a network 40 to which a node 12 connects may, in turn, be connected through a router 56 to another network 58. In general, nodes 12 may be on the same network 40, adjoining networks (i.e., network 40 and neighboring network 58), or may be separated by multiple routers 56 and multiple networks as individual nodes 12 on an internetwork. The individual nodes 12 may have various communication capabilities. In certain embodiments, a minimum of logical capability may be available in any node 12. For example, each node 12 may contain a processor 14 with more or less of the other components described hereinabove.

A network 40 may include one or more servers 60. Servers 60 may be used to manage, store, communicate, transfer, access, update, and the like, any practical number of files, databases, or the like for other nodes 12 on a network 40. Typically, a server 60 may be accessed by all nodes 12 on a network 40. Nevertheless, other special functions, including communications, applications, directory services, and the like, may be implemented by an individual server 60 or multiple servers 60.

In general, a node 12 may need to communicate over a network 40 with a server 60, a router 56, or other nodes 12. Similarly, a node 12 may need to communicate over another neighboring network 58 in an internetwork connection with some remote node 12. Likewise, individual components may need to communicate data with one another. A communication link may exist, in general, between any pair of devices.

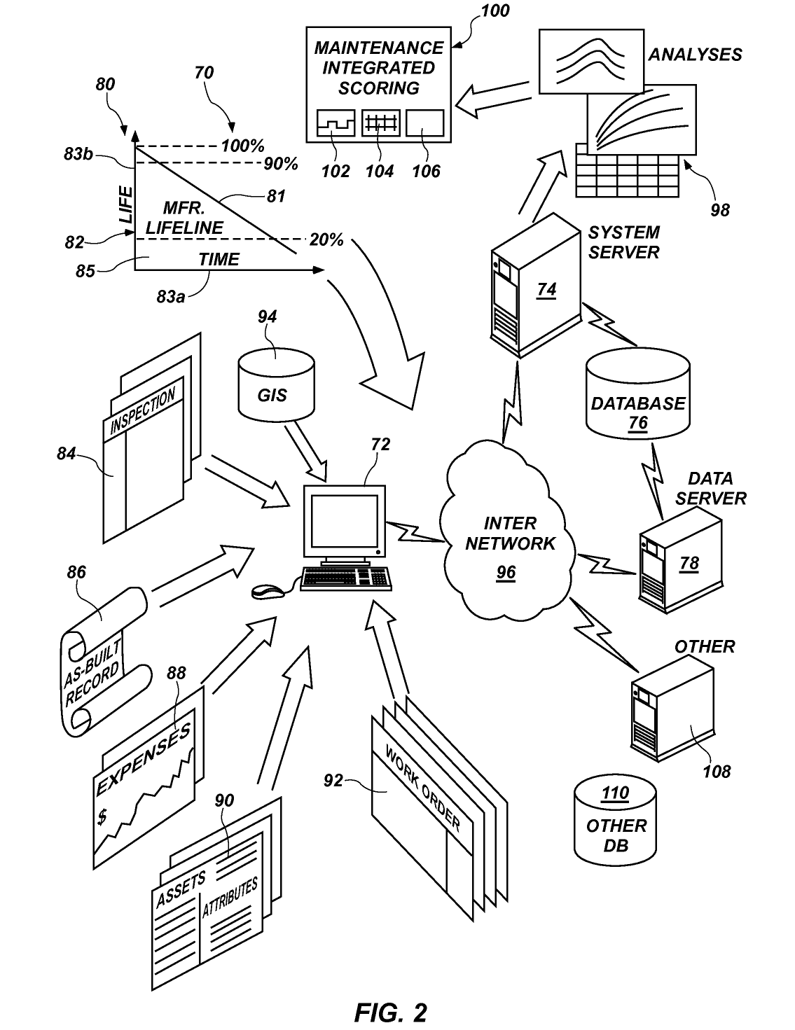

Referring to FIG. 2, a system 70 in accordance with the invention may rely on a station 72 or work station 72 operated by an employee, agent, responsible individual, responsible organization, or the like having responsibility with respect to certain aspects of infrastructure. Typically, infrastructure is associated with a city. Infrastructure may involve all those physical systems that make up the supporting systems of a city.

Similarly, industrial plants may likewise have infrastructure. However, in cities, particularly, much of the infrastructure is literally buried and not available for ready viewing, inspection, maintenance, or the like. Nevertheless, upon failure of certain systems, they may be excavated and inspected. Similarly, in some situations, systems may be shut down while cameras are run into lines to inspect those lines for condition.

The work station 72 may operate by a direct connection, or over an internetwork 96, to a system server 74. The system server 74 may access a database 76. In fact, the database 76 may be created and maintained by the system server 74. Nevertheless, the system server 74 may be connected to an internetwork 96 in order to provide information from the database 76 to users of that information, such as an operator of the work station 72.

A data server 78 or database server 78 may have responsibility for maintaining a database 76. In other embodiments, the data server 78 is simply responsible for performing certain functions to serve data from the database 76. For example, a database 76 may have a database engine that handles management of data inputs, reconciliations, verifications, as well as data outputs.

Typically, a query engine will be required in order to handle queries to the database 76. The data server 78 may have a query engine in a database engine programmed to operate therein. Similarly, the system server 74 may have a database engine. Typically, the database 76 will be controlled by only a single system or computer. Nevertheless, it is possible to have a synchronized database 76 accessed by multiple database engines, and reconciled in order to support such distributed access, input, and management.

In the illustrated embodiment, various information 80 may be provided through the work station 72. The information 80 may typically be uploaded to the database 76 by appropriate operation of the work station 72 in concert with the server 74 or the data server 78. Typically, the information 80 may include a chart 82 having axes 83a and 83b illustrating the passage of time on the axis 83a and the percentage of expected remaining useful life on the axis 83b.

In the illustrated embodiment, a curve 81 may be displayed in the domain 85 defined by the axes 83a, 83b. In the illustrated embodiment, the curve 81 is illustrated as a straight line. As a practical matter, the curve 81 may have a shape, but simple monotonic shapes are very typical. Straight lines are perhaps the most typical of manufacturers' and installers' life charts 82 provided with infrastructure assets installed.

Prior art systems rely substantially exclusively on the charts 82. Periodic inspections may result in the curve 81 being reset (elevated or depressed with respect to the vertical axis 83b according to an assessment of where in the remaining lifetime of an asset a particular asset has been revealed to be at a particular inspection). Meanwhile, a lifetime will typically be measured as a percentage of useful life.

Accordingly, at a time 83a of zero, installation has just been completed and the expected life or usefulness is one hundred percent or has a value of one hundred percent. In contrast, when the entire life has run out, the expected life is zero. However, at about or below twenty percent of expected life, maintenance typically becomes more expensive than capital expenditures, and an asset may be reviewed for replacement or upgrading.

However, as a practical matter, prior art practice has been to shift the curve 81 upward or downward, to reflect the actual, observed date or time on the axis 83a and the expected life value at that inspection on the axis 83b as represented by the curve 81. However, such a shift belies the reality. The fact that the particular asset has not operated along the curve 81 may be evidence that the slope of the curve, intervening maintenance, or other factors require consideration or could benefit the accurate determination of remaining life. Such factors should be incorporated into a better, real-life assessment.

Other information 80 may include, for example, inspections 84 or inspection records 84. As-built records 86 may include blueprints and other information that reflect the facts, materials, locations, configurations, conditions, and so forth of an asset and its surrounding environment at the time at installation. Similarly, expense records 88 or expenses 88 reflect expenditures both capital and maintenance. Expense records 88 may be maintained along with certain analyses of use between assets, years, or other parameters associated with an asset.

Meanwhile, asset records 90 may be combined in various forms or formats in order to identify particular assets and their attributes. Work orders 92 or work records 92 reflect a history 92 of work. However, all the information 80 may be thought of as history. Inspection reports 84 indicate what has been inspected, when, and typically will identify a condition of various assets according to certain parameters.

For example, a concrete pipe may have clogging, fracturing, pitting, or the like. Meanwhile, it may have a certain flow rate, may be sized to a certain capacity, might be documented as to its location, or the like. Meanwhile, as-built records 86, expenses 88, whether capital, maintenance, inspection, or otherwise, and other asset records 90 may all be useful as the total, agglomerated, historical record of an asset or system.

A geographical information system database (GIS database) may be available online database, or may be a dedicated database. A GIS database 94 may be available commercially and used by an operator of the work station 72. Moreover, the database 94 may be a partially extracted database 94 available from a larger database. In yet another embodiment, the database 94 may be a particular instance of a commercially available database, including non only geographical information but the local information regarding infrastructure locations linked to geographical information, in order to identify the locations, directions, dimensions, depth, and so forth, or other attributes and identifiers associated with various infrastructure assets.

In the illustrated embodiment, the internetwork 96 may connect the work station 72, the system server 74, and the like to one another or other computers 108 and other databases 110. Typically, other computers 108 may be other serves 108 that are responsible to provide data. For example, various websites are served by servers 108 providing information regarding products, services, organizations, and the like.

Meanwhile, numerous repositories of data may be accessible on other computers 108. In fact, online databases 110 may provide legacy information regarding any number of facts, systems, events, locations, and so forth. Thus, in certain embodiments, the work station 72, the system server 74, the data server 78, or the like may access and mine other computers 108, such as informational servers 108, as well as databases 110 or other sources of information. This may be a valuable source of information for similarly situated systems.

For example, a manufacturer, installer, or owner of other infrastructure may include similar materials, similar climate, or other attributes of similar infrastructure assets, or the like, or have data or reports regarding them. The system 70 may use that information in order to improve lifetime estimates or life projections. Meanwhile, such information may be used to perform statistical analyses or other analyses 98 on data.

For example, a work station 72 may be a dedicated work station or a captive work station owned by or responsible to a particular owner (e.g., city, industry, etc.) of infrastructure. Accordingly, that work station 72 will collect and work with the information 80 in the various records 82, 84, 86, 88, 90, 92, 94. However, a single system may be comparatively new and have no substantial history. Likewise, infrastructure, by its very nature, is not intended to see frequent service.

For example, water pipes are installed for decades, centuries, or longer. Power systems similarly have long lives. The information 80 available on a new system may be quite limited. However, other systems 108, 110 may have data available to assist in statistical, numerical methods, correlations, projections, modeling, and so forth.

If nothing else, other systems 108, 110 may simply provide additional data points for consideration. To the extent that the attributes of an asset can be identified in a system 70, similar attributes and information from similarly situated assets identified in other systems 108, 110 may likewise be used.

In the illustrated embodiment, analyses 98 may be performed by various analysis engines programmed for the task. Accordingly, integrated scoring records 100 or integrated scores 100 may be provided that reflect not only the actual status of particular infrastructure assets, but an integration of maintenance scores with condition scores, even augmented by life prediction scores. Life prediction scores may be actual, based on integrating condition scores and maintenance scores. They may include also projections of the effect of maintenance, and condition on the actual projected life of an asset.

For example, a real-life chart 102 may be included as part of the integrated scoring 100. Similarly, a user interface presentation 104 may provide opportunities for a user to graphically aggregate information and present it according to selection by attributes held in common, evidence comparatively similar, or the like.

Other presentations 106 may provide an ability to submit queries, an ability to conduct analyses, and even an ability to input hypothetical, “what if” types of questions into analyses in order to investigate options. Ultimately, the maintenance integrated scoring 100 assists in weighing options between upgrading, replacing, and ignoring infrastructure assets.

However, in a most simplified embodiment, simply providing a real-life chart 102 of actual life that incorporates maintenance scoring is valuable. A projection for the improvement in the life of an infrastructure asset is extremely valuable, and unavailable in prior art methods.

Most prior art methods are largely subjective, limited to inspections, vendor life curves, and manual access. These preclude an effective assessment of rates of change (mathematical first derivative) of condition, rates of change of those rates of change (mathematical second derivative), and so forth. Moreover, projections are not available. Rather, an individual human being may review a condition, at the time of a repair or with the cost of a scheduled (and typically expensive inspection), and thereby estimate an expected remaining life percentage.

Data available conventionally have been so sparse that such assessments are of only marginal value, and are not universal across an infrastructure system. For example, no city was built in a day. No city infrastructure assets of any type were typically installed all in a day. Accordingly, infrastructure systems will not deteriorate in a single day, or be deteriorated on a single day.

For example, snow and temperature (climate) conditions may change throughout a city. Climate conditions change over elevation, and with respect to geological features, such as bodies of water, geologic formations, and the like.

Climate may dramatically influence certain conditions. Frost heaving is ubiquitous in environments that have deep freezing in the wintertime, and substantial water. Thus, comparatively northern climates having comparatively large annual rainfall quantities or values may be more susceptible to frost damage to infrastructure elements such as pipes, roads, streets, and so forth. Similarly, installers vary from system to system, from project to project, and from week to week.

For example, a particular project may be installed by one installer, and a second phase or a continuing phase may be installed by a separate installer years or decades later. The skills, practices, and other attributes of a particular installer may overwhelm other factors. Similarly, geology may overwhelm other factors.

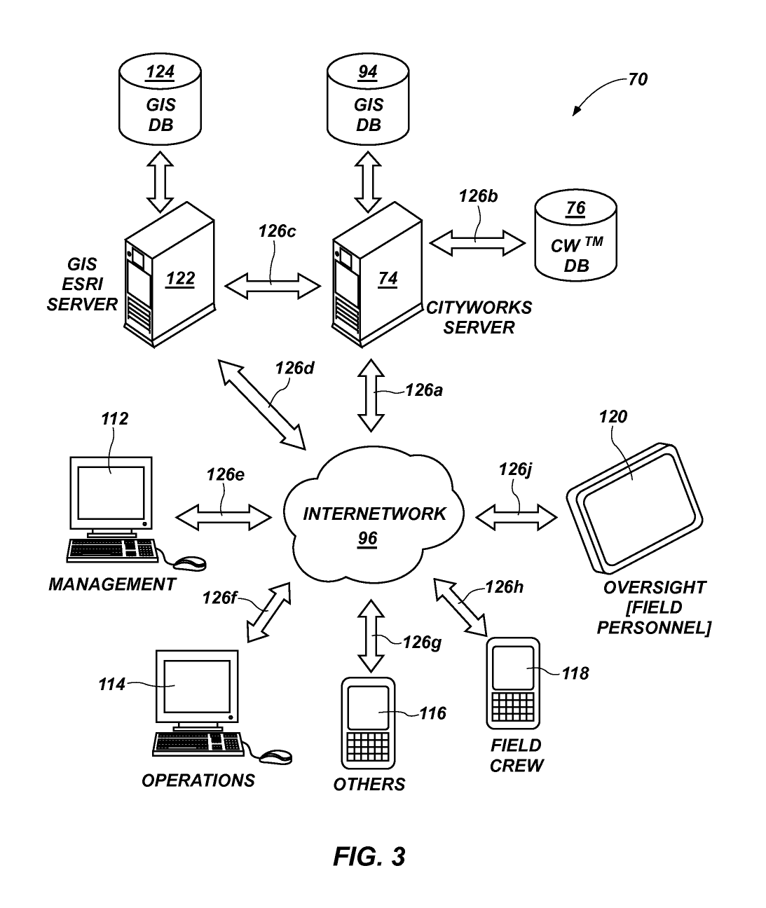

Referring to FIG. 3, in one embodiment of a system 70, various hardware assets 132 or apparatus assets 132 may be involved. For example, in the illustrated embodiment, a work station 72 may be embodied in any management computer 112 serving individuals in a management capacity over an infrastructure system. Meanwhile, an operations computer 114 may serve those who work in operations. Typically, management 112 may be thought of as city managers, departments' managers, and so forth. Meanwhile, an operations computer 114 may serve the day to day operations of particular individuals and organizations responsible to actually purchase, maintain, service, repair, and otherwise work on infrastructure assets.

Similarly, others, such as engineering departments, information technology departments, GIS support organizations, and other administrative staff and operational staff may rely upon other computers 116 or other computing devices 116.

Field organizations may rely on field computers 118. For example, crews onsite may rely on mobile computers 118 in order to obtain data, conduct tests or checks, or report in on particular activities of installation, maintenance, repair, inspection, or the like.

An oversight computer 120 may be thought of as a computer 120 operated by or on behalf of those having oversight over a system of infrastructure. For example, those with responsibility to make decisions on purchase, maintenance, service, and the like may be thought of as those having oversight 120. In many embodiments, an oversight computer 120 may actually be under the use and control of a governmental agency having oversight over those who may manage through a management computer 112 an infrastructure system.

In the illustrated embodiment, the various computers 112 through 120 may operate directly with one another, over a network, or over an internetwork 96, such as the internet, for example.

Meanwhile, a server 74 accessing a GIS database 94 may maintain a City Works™ database 76 for use by the computers 112 through 120. Typically, the database 76 may be dedicated to a particular infrastructure. In certain embodiments, the server 74 may actually be either dedicated to a particular infrastructure system, such as that owned by a single city, or may be an online server 74 available over internetworks 96, and hosting databases 76 of various, different, independent infrastructure systems.

Typically, although a GIS database 94 may be accessible, and even resident in a server 74, an ESRI server 122 may maintain a generic or generalized GIS database 94 124. Typically, the GIS database 94 is an extract, and may include additional information related to the various assets. Thus, the GIS database 94 may actually permit any particular user to access geographical information integrated with infrastructure information, in accordance with the invention, in order to integrate geography, space, assets, attributes and the like, in a single representation presented to a user.

Various communications 126 exist between the elements of the system 70. In the illustrated embodiment, and throughout this specification, a trailing reference letter indicates a specific instance of the base reference numeral. Accordingly, the communication 126a between the server 74 and an internetwork 96 is simply a specific instance of communications 126. Accordingly, the communications 126b, 126c, 126d, 126e, 126f, 126g, 126h, 126j are specific instances of communication used by the various devices in communicating with one another to upload, download, and otherwise access information, such as the information 80.

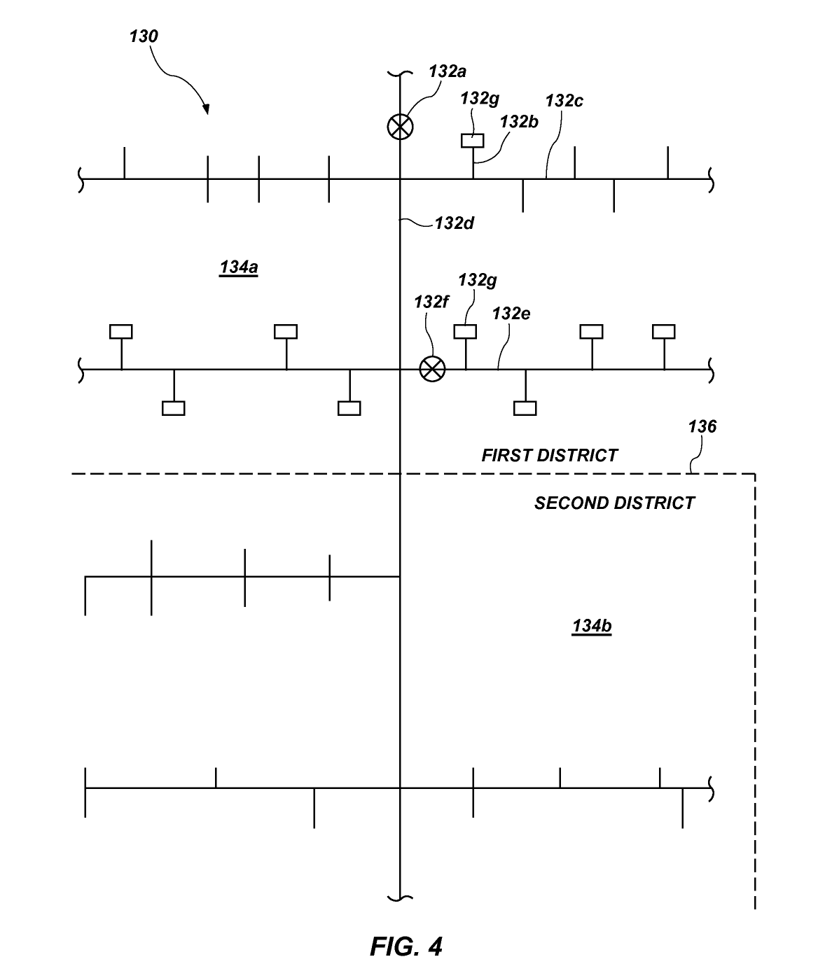

Referring to FIG. 4, a map 130 or chart 130 represents a topology 130. In certain embodiments, the topology 130 may actually be viewed as schematic representations of various infrastructure assets overlaid on an actual map. That map may be provided in any amount of graphic detail, accuracy, reality, scaling, or the like. In certain embodiments, the topology 130 may integrate information from the GIS database 94 along with asset information or attributes from the database 76.

In the illustrated embodiment, various assets 132 are shown. These assets 132 may be, for example, valves, control boxes, or various junctions, junctures, or the like. Meanwhile, such assets 132 may include various lines 132b, 132c, 132d. Those lines 132 may represent any type of an interconnection between other assets. For example, the asset 132a may be a valve controlling water. The water may be distributed through various lines 132b, 132c, 132d. For example, a main 132d may deliver water to a spur line 132c, which also delivers water to a specific delivery location line 132b. Meanwhile, other terminal units 132g may exist at the terminus of a particular delivery line 132b. Various lines 132e and controls 132f may exist within the infrastructure topology 130.

Meanwhile, the area, where the divide may be shown schematically according to responsibility, or physically according to region or area, may be identified by some particular parameter or indicator. For example, in the illustrated embodiment, the topology 130 is divided between districts 134a, 134b. A boundary 136 establishes the limits of the adjacent districts 134.

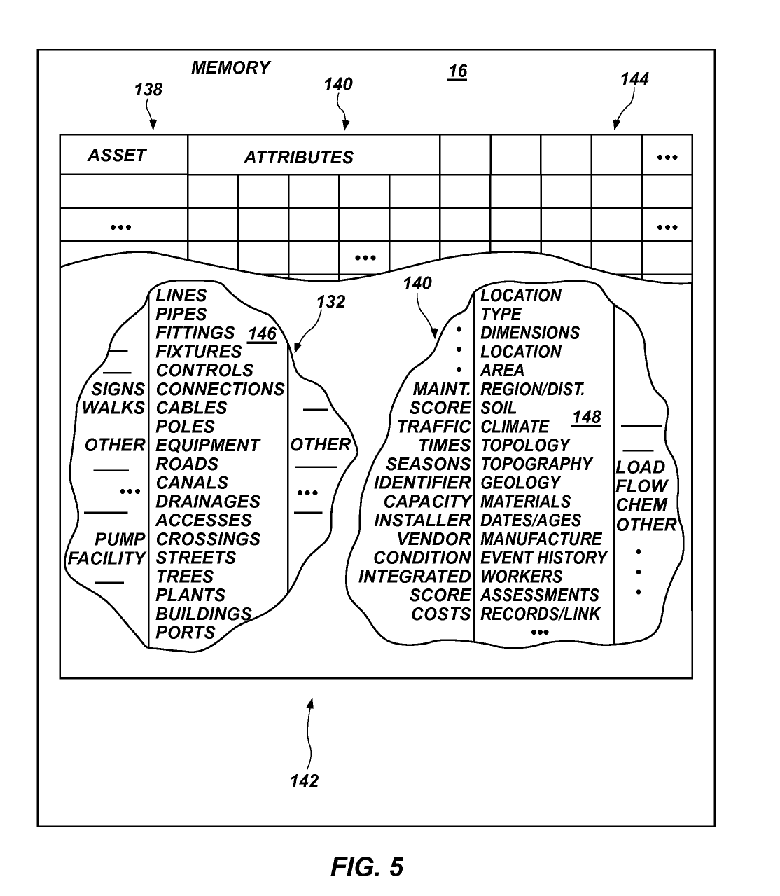

Referring to FIG. 5, various assets 132 may be characterized or identified by an identifier 138 or ID 138. Associated with each asset 132 may be various attributes 140. In the illustrated embodiment, a particular asset 132 may have associated therewith an ID 138 and a host of attributes 140 in an asset record 142. Asset records 142 may be individual records, or may simply be entries, lines, or rows within a particular table 144.

In the illustrated embodiment, a list of assets 132 or names 146 of assets is shown. They are schematically illustrated as the names 146 or the list 146 of names of assets 132 corresponding to the identification 138. Similarly, a list 148 of attributes 140 is illustrated schematically. They 140 appear in an underlying list 148 from which attributes 140 may be selected, or indicated.

In the illustrated embodiment, assets 132 include, for example, lines, pipes, fittings, fixtures, controls, connections, cables, poles, equipment, roads, canals, drainages, accesses, crossings, trees, streets, plants, buildings, ports, airports, water ports, ports of entry, signs, walks, pumps, facilities, and other possible assets 132. Meanwhile, some typical attributes 140 include such characteristics as location, type, dimensions, area, region, district, soil, climate, topology, topography, geology, materials, dates, ages, times, manufacturers', events, history, workers, assessments, records, links, traffic, seasons, identifiers, capacities, installers', vendors, conditions, integrated scores, costs, loads, flows, chemistry, maintenance scores, integrated scores, and other attributes 140 that may characterize a particular asset 132.

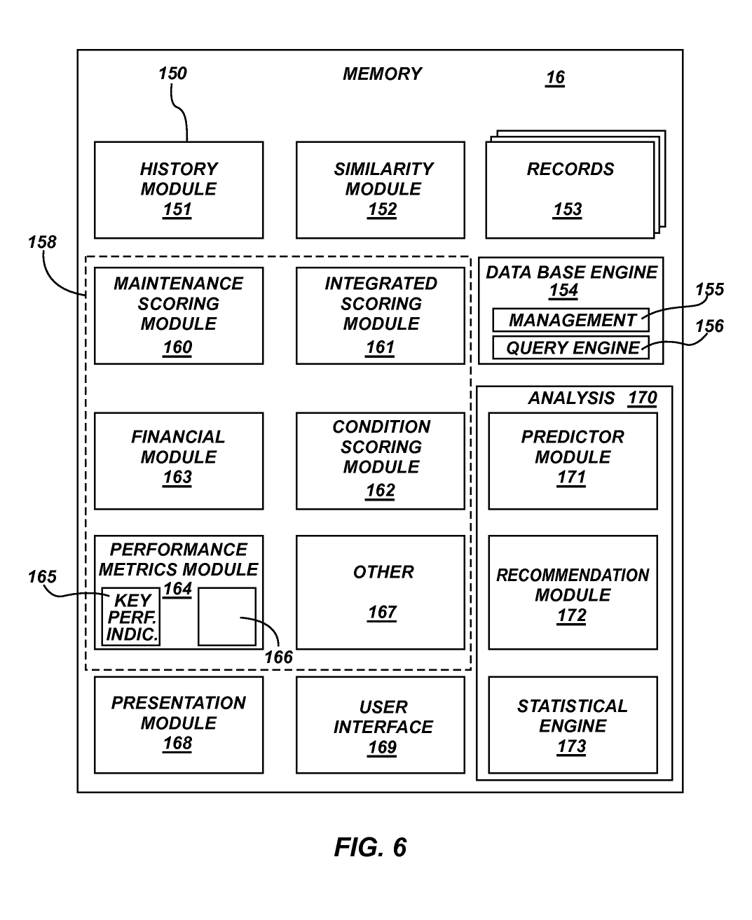

Referring to FIG. 6, in memory 16 associated with a particular computer 12 or computing device 12 in accordance with the invention, may be hosted a number of modules 150 for loading into a processor 14 for execution. In the illustrated embodiment, a history module 151 may be responsible for gathering, maintaining, and otherwise handling historical information. This may involve accessing, creating, downloading, or otherwise handling various records as having been discussed hereinabove.

Meanwhile, a similarity module 152 may be responsible for gathering historical information and linking information that relates similarly situated assets 132 and attributes 140 for use in combination with the historical data obtained by the historical module 151. Of course, a database 76 will maintain information, such as records 153. However, the history module 151 and the similarity module 152 may also be tasked with the job of mining, locating, perusing, parsing, and otherwise extracting data either from the records 153 of the database 76, or from other servers 108 or other databases 110 as described hereinabove.

In the illustrated embodiment, a database engine 154 may be responsible for managing a database 76. For example, a management module 155 may be responsible for the intake of records 153, and the proper storing, indexing, and other administrative functions of the database engine 154 in maintaining records 153. Meanwhile, a query engine 156 may be responsible for receiving queries and to output responses thereto from the records 153 for users of the database 76.

A scoring module 158 may be thought of as a set of other modules responsible for various evaluation or scoring activities.

For example, a maintenance scoring module 160 may be responsible for gathering and maintaining scoring for particular assets 132. Maintenance scoring modules 160 may be created for specific assets, or may be programmed into a single module 160 for handling any one of several assets 132. For example, a maintenance scoring module 160 may be responsible for providing templates and dialogue boxes in order for a user to input various events, activities, records, numbers, values, and the like that reflect activities that will eventually be managed in order to create maintenance scoring. Meanwhile, the maintenance scoring module 160 may be responsible to process the data in order to develop and maintain a current maintenance score for a particular asset 132, a system, or the like.

Similarly, a maintenance scoring module 161 may be responsible to integrate the results of a condition scoring module 162 and a maintenance scoring module 160. For example, a condition scoring module 162 may be responsible for receiving, inputting, outputting, processing, and otherwise obtaining and maintaining condition scores associated with a particular article 132 of infrastructure.

For example, to the degree of granularity that an infrastructure may identify specific assets 132, the maintenance scoring module 160 and condition scoring module 162 may be responsible for collecting information and using information, processing. This may include information regarding maintenance activities and condition inspections needed to provide an integrated score from the integrated scoring module 161.

In various embodiments, a maintenance scoring module 160 may operate alone. In other situations, a condition scoring module 162 may operate alone. On the other hand, an integrated scoring module 161 may rely on both maintenance and inspection information in order to provide an integrated score that reflects a prediction of remaining life (useful life, or utility) in a particular asset 132.

A financial module 163 may be responsible for collecting, analyzing, processing, and otherwise handling financial information. For example, whenever maintenance occurs or an inspection occurs, certain financial costs are involved. A capital expenditure, whether it be a new acquisition or an actual payment against a particular mortgage of an asset 132, will create a financial event. Accordingly, the financial module 163 is responsible for collecting, tracking, processing, and outputting information regarding financial information related to the acquisition, inspection, maintenance, repair, and so forth of a particular asset 132.

In certain embodiments, a performance metrics module 164 may be responsible for obtaining, processing, outputting, presenting, and otherwise managing performance metrics. For example, performance metrics 164 may be related directly to a condition or maintenance of an asset 132.

On the other hand, performance metrics 164 may relate to the teams, crews, organizations, departments, and the like responsible for particular assets 132 or collections thereof. For example, certain performance metrics 164 may include the average, maximum, minimum, or other time by which a service request is completed.

Likewise, certain types of work orders may be identified as to the date of their opening, their closing, and all days on which work was performed against the order. Meanwhile, costs of particular operations, such as maintaining lines, cleaning lines, re-lining pipes, and so forth may be identified. Also, performance metrics 164 may involve minimum, maximum, continuing, periodic, or net annual costs for a particular operation.

Meanwhile, labor costs, overtime costs, and the like may be performance metrics tracked by the performance metrics module 164 in order to give some clear indication of the effects of the condition, maintenance, and the like of an asset 132. Particularly, performance metrics 164 may be indicators that maintenance is required. By the same token, performance metrics 164 may also indicate the benefit to be realized by an upgrade. For example, maintenance or repair has affected the cost, life, or both of a particular asset 132.

Key performance indicators 165 maintained by the performance metrics module 164 may involve any or all of the parameters by which performance is measured. Typically, a lead time or time between a request for work and a response, whether a contact response to the requester, the initiation of work, the completion of work, or the like. Any or all such time spans may be set as a performance parameter.

Even a goal or standard may be set as a key performance indicator 165 for any particular activity, cost, or other parameter. Such goals then may work into key performance parameters by way of whether or not a particular key performance parameter, when measured as reported, meets a minimum, maximum, average, or other quantifiable standard.

Other parameters 166 or outputs 166 may be obtained, processed, output, or managed by the performance metrics module 164. These may be selected by individuals responsible for oversight, management, operations, support, or field completion of tasks.

Other modules 167 may exist within the system 150 of modules, within the scoring module 158 or life module 158, or both.

A presentation module 168 may provide for graphical presentation to a user of information related to individual records 153, combination of records 153, historical aggregations, comparisons with similarly situated systems or assets 132, and the like.

The presentation module 168 may be operated through a user interface 169 by which a user may select various information for presentation by the presentation module 168.

Typically, the presentation module 168 will be responsible to obtain information from other modules 150 in order to provide a graphical presentation. Thus, a presentation module 168 may actually do a certain analysis, but will typically be involved with analysis associated with graphical representations, aggregations, historical tracking, and the like.

In certain embodiments, a system of modules 150 may include an analysis module 170. Typically, a predictor module 171 may be of most value. The predictor module 171 may operate, for example, by using numerical methods solutions to complex equations, curve fits, and the like in order to predict more precisely the life expectancy or the remaining life utility of a particular asset 132 or combination thereof. In certain embodiments, a recommendation module 172 may actually use the predictor module 171, or the outputs thereof, or both in order to compare costs and render a recommendation.

An analysis module 170 may include several other modules 171, 172, 173. Typically, one basic module is a statistical engine 173. For example, various information may be of statistical significance from the various records 153 associated with various infrastructure assets 132. The frequency of repairs, the times and duration offline for repairs, the actual usable time, the duty time, time between failures, times during failures, repair time, the man hours required for repairs, the costs, and so forth may all give rise to statistics that may be analyzed by the statistical engine 173.

By analyzing statistics, the statistical engine 173 may correlate various assets 132 according to selected attributes 140. For example, correlations between assets 132 having similar attributes 140 may provide information regarding suitability of materials, installers, vendors, seasons, ages, regions, geographies, geologies, climates, and the like. They may inform oversight agencies and managers in making determinations as to expected life, expected costs, and so forth. Similarly, a predictor module 171 may use numerical methods, curve fitting, and other sophisticated analysis to predict functions, remaining life percentage values, rates of change of condition, maintenance activities, or function, capacity, or other attributes 140 as they depend upon other facts, factors, or attributes 140. Typically, the predictor module 171 may prepare prediction equations that provide predictions of life, life increase, rate of life decay, rate of life improvement, and so forth.

For example, certain activities by way of repair, service, and the like may provide an increase in the expected life or the useful life of an asset 132. Every activity will not provide the same restoration of life. Thus, a predictor module 171 may provide predictor equations by way of numerical methods, curve fits or the like. Typically it 171 will identify the increase in life based on particular events or activities, such as repairs, replacements, refurbishments, and the like. Thus, the predictor module 171 greatly enhances the accuracy of predicted life or the expected life of a particular asset.

By the same token, a recommendation module 172 may go a step further and use the predictor module 171, or the outputs thereof, in order to compare financial costs from the financial module 163 with predicted life from the predictor module 171. Accordingly, one with oversight or management responsibility may then learn how much life may properly be added to the useful term of an asset 132 if certain activities are undertaken. Thus, the recommendation module 172 may be programmed for providing a sensitivity analysis of how much life per dollar may be provided by any particular service or rehabilitation activity in the maintenance of an asset 132.

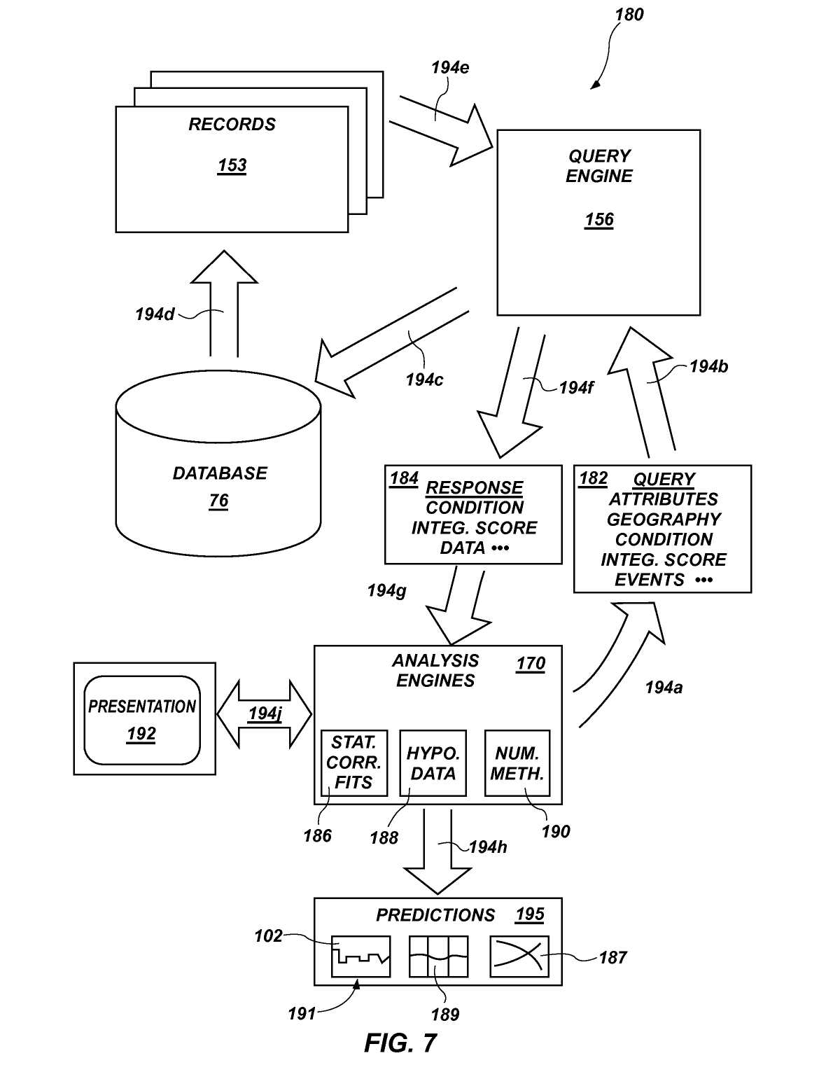

Referring to FIG. 7, a process 180 for implementing an apparatus and method in accordance with the invention may rely on the database 76 and records 153 in order to provide for viewing, considering, analyzing, comparing, and otherwise extracting information from data in order to provide information for decision makers. For example, in the illustrated embodiment, a particular analysis engine 170 or a module therewithin may analyze information from a query to determine, select, and pass information based on a query 182 to a query engine 156. The query engine 156, may thus communicate 194c with a database 76.

The query engine 156, querying the database 76, may elicit a communication 194d providing records 153 back to the query engine 156 for formulation and delivery 194f of a response 184. The response may include a condition, data, charts, graphs, figures, and the like. In one embodiment, a maintenance score (e.g. adjustment of remaining percentage of life) may be returned.

In other embodiments, an integrated score integrating both maintenance scores and condition scores to provide an effective life may be returned. In certain embodiments, an analysis engine 170 may implement other modules 186, 188, 190 in order to accomplish its desired results. For example, a statistical module 186 may do correlations, curve fits, and so forth of historical, statistical, or other data.

Meanwhile, a hypothetical data module may provide for inputs of hypothetical conditions in order to test the expected or probable percentage change in life expectancy if certain hypothetical actions were taken.

Likewise, a numerical methods module 190 may implement functionality, such as that of a predictor module 171 discussed hereinabove. Accordingly, the analysis engine 170 eventually communicates 194h predictions 195. In the illustrated embodiment, a real-life chart 102 may be presented. In the illustrated embodiment, the chart 191 may include a life curve 102 much improved over that of a manufacturer or installer. For example, the chart 191 may present a real-life curve 102 that indicates the actual historical life, and a predicted life, based on integrating a maintenance score into the upgraded life profile 102.

Similarly, a chart 189 may provide an integrated score based on certain events occurring at certain times to alter the life. A comparison chart 187 may provide a Juxtaposition of certain curves. For example, it may combine for comparison and display the cost of maintenance, cost of ownership, capital expenditure, or the like. Accordingly, trade offs may be determined by a comparison chart 187 that contains predictors of life, expense, maintenance costs, capitalization costs, technology improvements, or the like.

In one embodiment, a presentation 192 may be provided from the analysis engine 170 directly, or from storage 16, in response to inputs from a user, or the like. Communication 194j between the analysis engines 170 and the presentation 192 may permit interaction. A user, through a user interface 169 may obtain underlying support from the presentation module 168 in order to prepare the presentation 192, and provide the outputs to a user.

Typically, a presentation 192 will include spatial (e.g. geographic, regional), temporal (time-based), color, and other features in order to render the information presented more isolated, identifiable, aggregated, grouped, collected, reduced, or otherwise made more understandable. Meanwhile, the presentation 192 may include information extracted, filtered, and otherwise collected and presented. This may be done according to space, time, asset 132 type, attribute 140, or the like. Thus, one may search for particular assets 132 of a particular type that share certain attributes.

The presentation 192 may provide various charts comparing assets and attributes. It may thus provide great insight to an individual responsible for execution, inputs, decisions, management, oversight, or operation of a system 70 in accordance with the invention.

The communications 194a through 194j may operate to collect, fetch, output, read, write, process, or otherwise transfer data between modules, between hardware, between the individuals, between databases, or the like. Accordingly, a user may access any particular information or data, and have it presented as useful information informative for decisions.

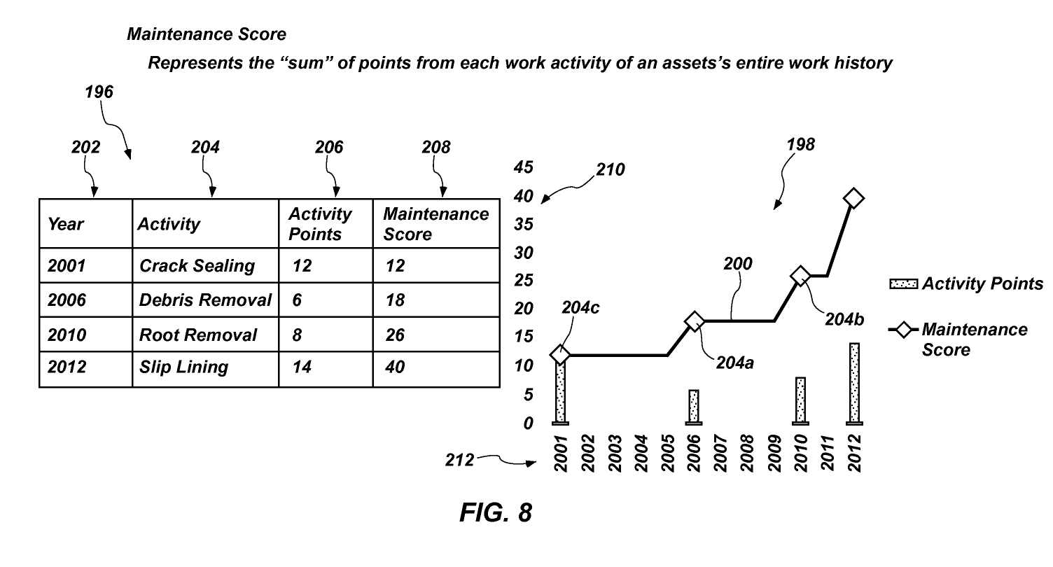

Referring to FIGS. 8 through 10, in certain embodiments, information may be obtained with minimal complexity, minimal mathematical manipulation, and so forth. For example, prior art methods and apparatus known to Applicant have no inclusion of maintenance as a separate life-extending factor. Maintenance represents a cost in any physical system. However, maintenance may be of several different types. A repair may simply return a non-functioning unit or asset 132 into a functioning unit. It may not extend the life at all. Similarly, certain types of maintenance are simply required. Lubrication of machine parts, removal of debris, and so forth are routine maintenance that may not affect life.

On the other hand, replacement of key components may extend life. Repair of key components may extend life. For example, water lines that have existed for decades or centuries in certain cities may be re-lined by modern techniques.

Such re-lining procedures may give a structure an entirely new life. For example, new polymeric tubes may be inserted into a conventional stone, concrete, or cast line, greatly improving the life. Meanwhile, cleaning, removing roots, and the like from drain lines may provide increased life, but may also be required periodically simply to maintain function.

Referring to FIG. 8, a table 196 is shown along with a graphical representation of a chart 198. In the illustrated embodiment, a score 200 (or a curve 200 providing a value 200 representing a score) of remaining percentage of life is illustrated. In the illustrated embodiment, a year 202 is represented and various events 204 are identified. Associated with each event 204 or activity 204 is a value 206 called points 206. Here, the points 206 amount to a percentage of life extended by virtue of the respective activity 204 or event 204.

A cumulative score 208 represents the total number of points 206 accumulated. The accumulated or cumulative points 208 effectively should be subtracted from the degradation of an asset 132. Put another way, the points 208 represent percentage points by which the life of an asset 132 is extended by virtue of the combination of various activities 204 or events 204.

Illustrating the data from the table 196 in the chart 198, the life 210 or the value 210 along an axis 210 represents a percentage of life. Meanwhile, another axis 212 represents the years 202 from the table 196. In various locations, certain events 204a, 204b, 204c are illustrated schematically.

Associated with each event 204 is a particular resultant change or establishment of the value of the curve 200. Thus, the curve 200 represents the life 210 or percentage of life added by virtue of the particular activities 204 or events 204. Thus, in the illustrated embodiment, a value of remaining life originally was between ten and fifteen percent remaining. It was extended to about forty percent. Thus degradation was reversed and the life score 200 was extended.

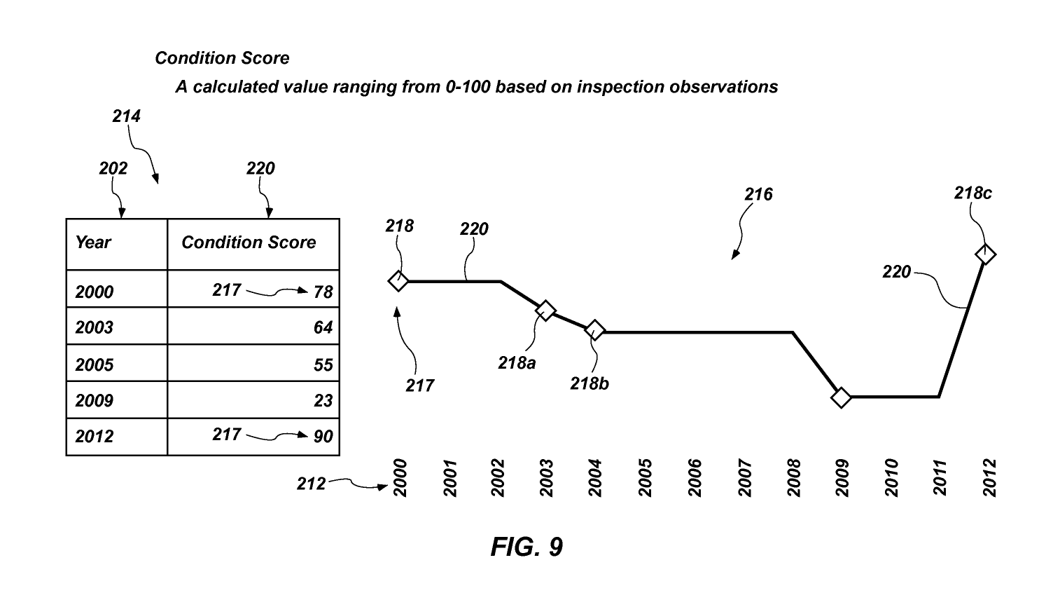

Referring to FIG. 9, a condition score is illustrated. A table 214 contains information relating the numerical values of the chart 216 therein. At any chart location or year 202, a value 217 is associated. One may think of each of the entries in the table 214 is representing an inspection. Thus, for any year 202 listed, a value 217 of a score 220 is listed. In the illustrated embodiment, various inspections 218 identify particular years 202 along the timeline 212 or axis 212. Accordingly, the condition score 220 alters between inspections 218 occurring at various dates 202.

In general, a condition score 220 simply reflects an assessment by a knowledgeable professional who has inspected a particular asset 132. A score 220 may have a certain amount of uncertainty and subjectivity. To the extent that information may be obtained quantitatively (such as by testing), the score 220 may be more reliable and objective.

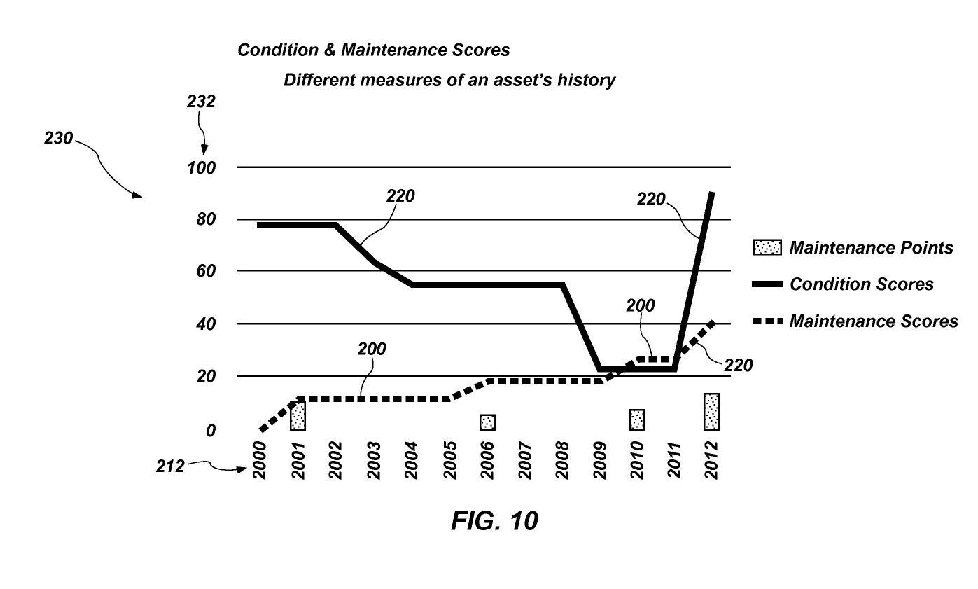

Referring to FIG. 10, an integrated or combined chart 230 illustrates an axis 232 representing remaining life. The life 232 or the life axis 232 represents a percentage of remaining useful life corresponding to a particular asset 132. In the illustrated embodiment, the charts 198, 216 are combined. Thus, each relies on the same timeline 212 or time axis 212. Similarly, each relies on the same life axis 232.

One may see how the maintenance score 200 integrated with the inspection score 220 results in a different value 217 for the condition score 220. Due to the knowledge imparted by the points 206 and the accumulated or cumulative points 208 additional life 232 is credited to an asset 132. An integrated chart 230 provides greater insight, and a more realistic, or real-life, curve 102 (see FIG. 7) for the life expectancy of the asset 132.

In many instances, the chart 220 may not even be available. That is, the curve 220 represents a condition that may or may not be available for inspection. However, maintenance scores 200 provide the ability to augment condition scores 220 in order to provide a more realistic condition score 220 or an integrated condition score 220. In certain embodiments, an integrated, maintenance, condition score 200 may provide a better detail on the expected life.

Meanwhile, the analysis engine 170 takes the chart 230 to a different level. Using the predictions 195 from the analysis engine 170, other information, such as that obtained from other databases 110, other servers 108, and the like may provide similarity data from the similarity module 152. For example, certain records 153 may actually represent documentation from the similarity module 152. Thus, modeling by the analysis engines 170 may provide additional data to the system 70 in situations where either condition scores 220, maintenance scores 200, or both are either absent, or sparse. Thus, interpolation, extrapolation, and modeling by the analysis engines 170 may provide more realistic life charts 230.

The present invention may be embodied in other specific forms without departing from its purposes, functions, structures, or operational characteristics. The described embodiments are to be considered in all respects only as illustrative, and not restrictive. The scope of the invention is, therefore, indicated by the claims, rather than by the foregoing description. All changes which come within the meaning and range of equivalency of the claims are to be embraced within their scope.

Wherefore, we claim:

1. A method comprising:
receiving, by a computer system comprising at least one computing device, inspection data reflecting inspection of the condition of each of a plurality of assets, the assets constituting an infrastructure system;
identifying, by the computer system, types, each type corresponding to a component constituting a structure having a function and physical characteristics reflecting the ability of the type to accomplish the function;
selecting life parameters reflecting operational life of each of the respective types;
determining, by the computer system, for each of the types, a life value corresponding to the each of the types and respective life parameters corresponding thereto;
creating, by the computer system, a condition score for each type, the condition score reflecting the life value for the each type, based on at least one of an inspection and another assessment of an instance of the type after an installation event;
creating, by the computer system, a maintenance score for each type, reflecting a change in the life value corresponding to a maintenance event of a plurality of maintenance events corresponding to the each type of the plurality of types, respectively;
calculating, by the computer system, an integrated score reflecting the expected operational lifetime of a subject component as a specific instance of the type, based on analyzing together the condition score and the maintenance score corresponding to the specific instance as installed in the infrastructure system.

2. The method of claim 1, wherein:
the inspection data represent a physical condition observable by at least one of a sensor, electronic communication device, visual observation; and destructive testing; and
the plurality of maintenance events is selected from the group consisting of measuring, adjusting, exposing for visual inspection, cleaning, repairing, replacing, refurbishing, and modifying.

3. The method of claim 1, wherein the determining, further comprises analyzing data reflecting a change in physical status, of the subject component, corresponding to the maintenance events and at least one of the types and instances of the components of the types.

4. The method of claim 1, further comprising:
providing a computerized database hosted on the computer system and comprising database records including type records corresponding to the types;
creating component records corresponding to the components by analyzing, in the computer system, component information corresponding to the types and the components, wherein the components are instances of the types;
creating in the component records, fields corresponding to the maintenance events and the physical condition of the components; and
storing the component records.

5. The method of claim 4, further comprising;
providing a computerized database hosted on the computer system and comprising database records including the component records; and
creating, by the computer system analyzing the subject component, based on the inspection data, maintenance data from a subject component record corresponding to the subject component.

6. The method of claim 5, further comprising:
providing inspection criteria to the computer system on which to base the analyzing of the component information;
analyzing, by the computer system, a subject component, based on the inspection criteria.

7. The method of claim 6, wherein the inspection criteria correspond to at least one of:
analysis of the subject component itself, based on a visual inspection;
analysis of the subject component, based on measurable physical properties thereof;
analysis of a comparative component situated similarly to the subject component; and
analysis of destructive test data corresponding to a removed component of the same type as that of the subject component.

8. The method of claim 7, wherein
the analysis based on a visual inspection is provided an experienced expert visually inspecting the component.

9. The method of claim 6, further comprising:
analyzing, by the computer system, the estimated, remaining, useful life of the subject component, based on the inspection criteria.

10. The method of claim 1, further comprising:
selecting, as the subject component, an infrastructure asset
analyzing the subject component based on the inspection criteria;
evaluating a projected available life of the subject component based on the condition score and the maintenance score.

11. An article including a computing system comprising at least one processor operably connected to a memory, wherein the memory is constituted as a non-transitory, computer-readable memory device storing data structures constituting operational data and executables, the executables constituting instructions executable on the at least one processor for operating on the operational data, and the data structures comprising:
records corresponding to assets in the infrastructure, each asset being a component thereof;
a database linking information to geographical positioning of the assets and storing data reflecting attributes corresponding to the assets;
a system module for projecting remaining operating life of a subject component of the components in the infrastructure;
a history module responsible for gathering, maintaining, and otherwise handling historical information;
a similarity module responsible for gathering historical information and linking information that relates assets similarly situated and the attributes corresponding thereto;
a management module responsible for intake, storing, indexing and retrieving the records;
a query engine responsible for receiving queries, evaluating the queries, and selecting from the records in response thereto;
a scoring module comprising a maintenance scoring module programmed for determining a maintenance score for each of the assets by analyzing the effect on the respective lifetimes of the assets based on maintenance events corresponding thereto;
the scoring module, further comprising a condition scoring module programmed to receive inputs and calculate, based thereon, condition scores associated with the assets; and
the scoring module, further programmed to determine a projected lifetime of a selected asset of the assets based on evaluating both the condition scores and the maintenance scores.

12. The article of claim 11, wherein the scoring module is further programmed to integrate the condition score and maintenance score with a financial analysis comparing continued maintenance with replacement of the components.

13. The article of claim 11, further comprising:
financial module programmed for analyzing financial data reflecting at least one of inspection, a capital expenditure corresponding to a new acquisition of a new component for the infrastructure, an actual payment against a particular mortgage on the infrastructure, maintenance of the components, and repair of the components.

14. The article of claim 11, further comprising:
a performance metrics module programmed to process performance metrics relating performance of the assets to at least one of condition, maintenance, and both thereof, corresponding to the assets.

15. The article of claim 14, wherein the performance metrics module is further programmed to analyze at least one of teams, crews, organizations, departments, and individuals responsible for the assets.

16. The article of claim 13, wherein the performance metrics module is further programmed to analyze at least one of:
time elapsed and corresponding to at least one of the average, maximum, minimum, or other time by which a service request is completed;
types of work orders based on at least one of the date of their opening, their closing, and all days on which work was performed against the work orders;
costs of particular maintenance operations including at least one of labor, materials, kind of activity, periodicity, annual expense, maximum cost, minimum cost, and overtime cost for the assets;
the effects of the condition, maintenance, and cost of an asset of the assets;
scheduling of maintenance required;
benefits of the maintenance events;
benefits of an upgrade; and
the effects of at least one of maintenance, replacement, and both on at least one of the cost, life, or both of a the asset of the assets.

17. A computerized method for projecting an operational life expectance for assets in an infrastructure, the method comprising:
identifying, by a computer system comprising at least one computing device, a plurality of types, each type corresponding to a structure having physical characteristics and a function as a component in an interconnected infrastructure of components;
providing a computerized database hosted on the computer system and comprising database records;
selecting life parameters reflecting conditions corresponding to the types and corresponding to operational life of the types;
creating, by the computer system, a life value corresponding to the life parameters, by analyzing data reflecting a physical status corresponding to at least one of the types and instances of components of the types;
creating, by the computer system, a condition score for each type reflecting a life value for the each type, based on at least one of an inspection and another assessment of an instance of the type after an installation event;
creating, by the computer system, a maintenance score for each type, reflecting a change in the life value corresponding to a maintenance event of a plurality of maintenance events corresponding to the each type of the plurality of types, respectively;
calculating, by the computer system, an integrated score reflecting the expected operational lifetime of a specific instance of the type, based on at least one of analyzing together and otherwise combining together the condition score and the maintenance score corresponding to the specific instance as installed in the interconnected infrastructure.

18. The method of claim 17, further comprising analyzing effects of attributes on at least one of cost and maintenance, wherein the attributes are selected from location, type, dimensions, area, a region or district of responsibility, soils, climate, topology including connections, topography including elevation and geography, geology, materials, dates, ages, manufacturers, event history, workers who have accessed the asset, assessments by those who have worked on or accessed the assets, records, links, loads, flows, chemistry of contents of surrounding environments, traffic, times, seasons, identifiers, capacities, use cycles, duty cycles, vendors, installers, condition from inspections and reports, costs, condition scores, maintenance scores, and integrated scores based on condition scores and maintenance scores.

19. The method of claim 17, wherein the assets include lines, pipes, fittings, fixtures, controls, connections, cables, poles, equipment, roads, canals, drainages, accesses, crossings, streets, trees, plants, buildings, ports, pumps, facilities, walks, signs, and other physical structures in at least one of a city and an industrial plant.
